(19) United States
(12) Patent Application Publication
(10) Pub. No.: US 2014/0203118 A1
(43) Pub. Date: Jul. 24, 2014

(54) APPARATUS TO CONTROL THE DISPENSING OF A PRECISE AMOUNT OF GROUND COFFEE INTO AN ESPRESSO PORTAFILTER BASKET

(71) Applicant: FRANCISCO ALFREDO REGO, SUN VALLEY, ID (US)

(72) Inventor: FRANCISCO ALFREDO REGO, SUN VALLEY, ID (US)

(73) Assignee: ADAGER CORPORATION (THE), SUN VALLEY, ID (US)

(21) Appl. No.: 14/165,404

(22) Filed: Jan. 27, 2014

Related U.S. Application Data
(63) Continuation-in-part of application No. PCT/US2011/045507, filed on Jul. 27, 2011.
Application No. PCT/US2011/045507 is a continuation-in-part of application No. 14/110,359, filed on Jan. 21, 2014.

(51) Int. Cl. A47J 42/44; A47J 42/40

(52) U.S. Cl. CPC A47J 42/44; A47J 42/40
USPC 241/6

(57) ABSTRACT

A coffee-measurement apparatus (60) and related methods for precisely measuring and displaying the weight of ground coffee to be used for preparing espresso shots and espresso-based beverages. The coffee-measurement apparatus (60) includes a portafilter platform (80) positionable directly below an output portion (116) of a coffee-grinding apparatus (100). The portafilter platform (80) is coupled to a weight-measurement device (20) as well as to a display (66) so the net weight of the ground coffee in a basket (52) of a portafilter (50) resting on the portafilter platform may be measured and displayed. In some embodiments, the coffee-measurement apparatus (60) may be configured to automatically start the coffee-grinding mechanism (130) of the coffee-grinding apparatus (100) and to stop it when a desired weight of ground coffee has been dispensed into the basket (52) by utilizing an electronic connection and/or an electromechanical actuator (140) communicatively coupled to the coffee-measurement apparatus (60).

This application claims priority of PCT/US2011/45507 filed Jul. 27, 2011, and is a continuation-in-part of U.S. application Ser. No. 14/110,359 filed Oct. 7, 2013, which is a 371 National Entry of PCT/US2011/31260 filed Apr. 5, 2011, the disclosures of all of which are incorporated herein by this reference.

### FIELD OF THE INVENTION

The present invention relates to methods and devices for measuring ground coffee. More specifically, the present invention relates to methods and devices capable of precisely measuring and controlling the mass of ground coffee dispensed into an espresso portafilter basket for use in preparing espresso or espresso-based beverages.

### BACKGROUND OF THE INVENTION

All publications herein are incorporated by reference to the same extent as if each individual publication or patent application was specifically and individually indicated to be incorporated by reference. The following description includes information that may be useful in understanding the present invention. It is not an admission that any of the information provided herein is prior art or relevant to the presently claimed invention, or that any publication specifically or implicitly referenced is prior art.

Espresso is a concentrated beverage extracted by forcing hot water under pressure through finely ground coffee. As a result of the pressurized extraction process, the flavors in a cup (or “shot”) of espresso are very concentrated. For this reason, espresso coffee is the base for other drinks, such as lattes, cappuccinos, and mochas. When baristas (e.g., expert coffee makers) prepare an espresso shot, they are supposed to follow a precise discipline that includes controlling many parameters, such as the quality of the coffee beans used, the quality of the roasting process, the time lapse between roasting and grinding, the time lapse between grinding and extraction of the espresso shot, and the like. Entire industries have developed to control the temperature, pressure, and flow-rate of the water used by espresso machines.

After taking care of the aforementioned parameters, a barista decides how much mass of ground coffee to use when making an espresso shot. This amount of ground coffee is then placed into an espresso machine's portafilter. A portafilter generally includes a handle, a basket for holding the ground coffee, and may include one or more spouts. Some portafilters, generally referred to as bottomless or “naked” portafilters, may not include any spouts. Portafilters are usually made of metal and are kept warm before (and during) the extraction of espresso to maintain the high thermal stability required by the espresso process. Portafilters, holding ground coffee within their baskets, are attachable to an espresso machine, where they form a tight seal with the espresso machine's gasket. This tight seal allows for high-pressure hot water to be directed through the ground coffee to provide one or more shots of espresso.

At present, it is difficult to deliver a specified mass of ground coffee to an espresso machine's portafilter. One method that could be utilized involves the use of a conventional scale that measures the weight of the ground coffee (weight is an accurate representation of mass, because “weight” is defined as “mass multiplied by the acceleration caused by gravity”). For this method, a temporary weighing container could be placed on the scale and a quantity of ground coffee placed into the temporary container. The weight of the container may be subtracted out or otherwise accounted for. A utensil such as a spoon may then be used to add or remove ground coffee until the desired weight of coffee is in the container. Once the desired weight has been achieved, the ground coffee may then be transferred from the temporary weighing container into a portafilter.

As can be appreciated, it would be difficult to transfer the ground coffee from the weighing container to the portafilter without spilling any ground coffee or leaving any coffee behind in the weighing container, which would cause the amount of ground coffee that ultimately ends up in the portafilter to be different from the desired weight. This method would also be time consuming, which may be disadvantageous in production environments (e.g., coffee shops) where the quick preparation of espresso is important. Further, it may be difficult for baristas to maintain the required temperature of the portafilter (which is separated from the espresso machine during this complicated weighing process) due to the length of time required to measure the ground coffee and transport it between various containers.

For these and other reasons, most baristas do not use this method but instead rely on other techniques to roughly estimate the amount of ground coffee used when preparing an espresso shot. By estimating the amount of ground coffee rather than precisely measuring it, there is significant variability in the amount of ground coffee used for each espresso shot. This undesirable inconsistency results in espresso shots that have unpredictable flavors and other detrimental characteristics.

Recognizing the need to use a precise amount of ground coffee mass to make an espresso shot, manufacturers of coffee-grinding devices (“coffee grinders”) have developed methods that attempt to deliver a specified amount of coffee mass to a portafilter. Some coffee grinders (e.g., “closer” grinders) may use volumetric measurements. Other coffee grinders (e.g., “on demand” or “doserless” grinders) employ timers that allow them to run for a specified period of time that supposedly corresponds to a specified amount of ground coffee mass. Unfortunately, both measurements (the measurement of the volume of ground coffee, as well as the measurement of the dispensing time of ground coffee) can be inaccurate measurements of the mass of coffee involved in the process.

### SUMMARY OF THE INVENTION

Embodiments of the present invention are directed to an apparatus (also referred to as a “smart portafilter platform”) that controls the dispensing of a precise amount of ground coffee from a standard coffee grinder to an espresso portafilter's basket. A user of the apparatus is able to explicitly start the dispensing of ground coffee and, at any time, the user may choose to explicitly stop the dispensing of ground coffee.

In some embodiments, the invention comprises an apparatus including a portafilter platform configured to selectively position a portafilter's basket in a substantially horizontal orientation directly below an output portion of a coffee-grinding apparatus. The portafilter platform is coupled to a weight-measurement device that displays the net weight of ground coffee accumulated within the portafilter's basket. In these embodiments, the user constantly monitors a display of the apparatus and, when this display indicates that the net weight of ground coffee in the portafilter basket is equal to (or near) the desired weight, the user stops the dispensing of ground coffee.

In other embodiments, the invention comprises an apparatus that automatically performs the functions discussed above. These enhanced embodiments incorporate a controller that automatically stops a coffee-grinding apparatus when the net weight of ground coffee in the portafilter basket is equal to (or near) the desired weight of ground coffee. The controller includes an interface that permits the user to specify a desired weight of ground coffee (by entering a specific weight, or by choosing among several pre-specified weights that have been previously stored in the controller's memory). The interface accepts from the user (and transmits to the coffee-grinding apparatus) a signal to start the coffee-grinding process. The controller automatically provides a method to stop the coffee-grinding process when the net weight of ground coffee in the portafilter basket is equal to or near the desired weight of ground coffee.

The enhanced embodiments may have several implementations (e.g., electronic, electromechanical, or the like). With an electronic option, the apparatus controls the start/stop functions of the coffee-grinding apparatus by means of electronic signals that interface directly with the internal electronic components of the coffee-grinding apparatus. With an electromechanical option, the apparatus uses external actuators to manage the standard start/stop controls (e.g., switches, buttons, dials) of the coffee-grinding apparatus.

### BRIEF DESCRIPTION OF THE FIGURES

Exemplary embodiments are illustrated in the referenced figures. It is intended that the embodiments and figures disclosed herein are to be considered illustrative rather than restrictive.

FIG. 1A depicts a perspective view of a coffee-measurement apparatus in accordance with an embodiment of the present invention.

FIG. 1B depicts a perspective view of the coffee-measurement apparatus shown in FIG. 6A with a portafilter positioned on a portafilter platform.

FIG. 2A depicts a left-side elevational view of a portion of the coffee-measurement apparatus as shown in FIG. 1A.

FIG. 2B depicts a left-side elevational view of a portion of the coffee-measurement apparatus as shown in FIG. 1B.

FIG. 3A depicts a front elevational view of a portion of the coffee-measurement apparatus as shown in FIG. 1A.

FIG. 3B depicts a front elevational view of a portion of the coffee-measurement apparatus as shown in FIG. 1B.

FIG. 4 depicts a functional block diagram of an exemplary coffee-measurement apparatus in accordance with an embodiment of the present invention.

FIG. 5 depicts a perspective view of the coffee-measurement apparatus shown in FIG. 1A when configured to operate with an actuator to control a coffee-grinding apparatus.

FIG. 6 depicts a perspective view of the coffee-measurement apparatus shown in FIG. 1A when configured to operate with an actuator to control another coffee-grinding apparatus.

### DETAILED DESCRIPTION OF THE INVENTION

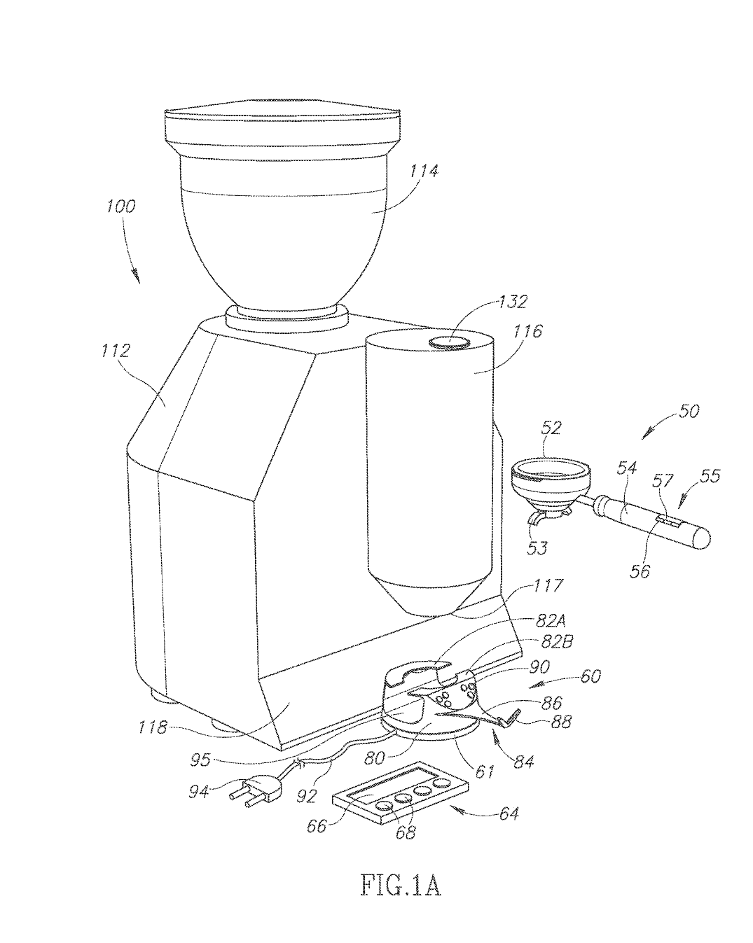

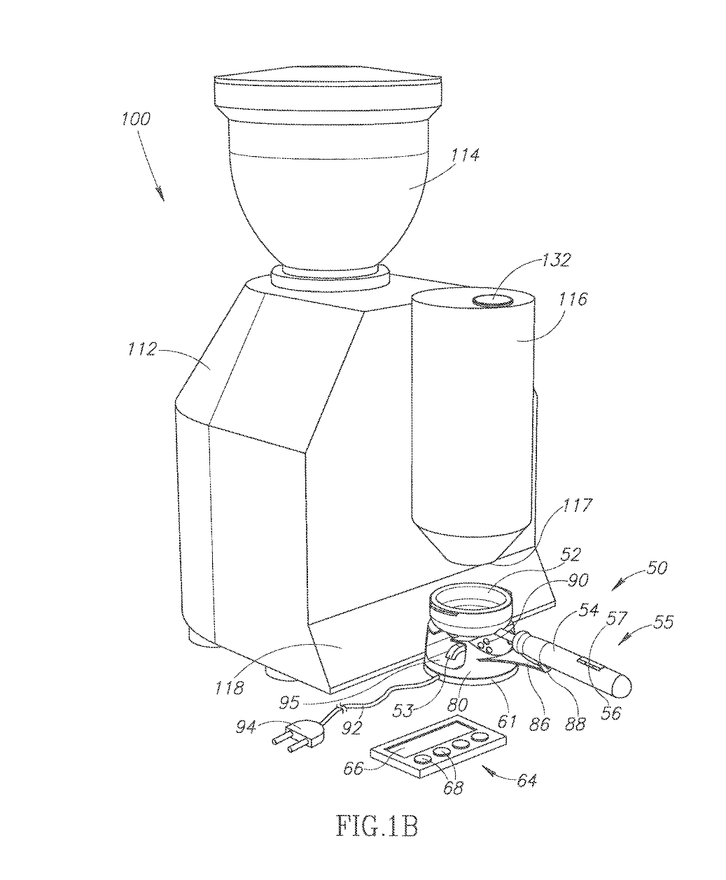

Referring now to the drawings in which like parts are designated by like reference characters throughout the several views. FIGS. 1A-B, 2A-B, and 3A-B depict a coffee-measurement apparatus 60 (also referred to as a “smart portafilter platform”) in accordance with an embodiment of the present invention. As used herein, the term “coffee-measurement apparatus” means “an apparatus for measuring ground coffee.” As described in further detail below, the coffee-measurement apparatus 60 enables a user of a conventional coffee-grinding apparatus 100 to dispense a precise mass of ground coffee, as measured by its weight, directly into a basket 52 of a portafilter 50 (also referred to as a “portafilter basket”) positioned on the coffee-measurement apparatus 60. In a sense, the coffee-measurement apparatus 60 “manages” the operation of coffee-grinding apparatus 100 to provide improved functionality thereof.

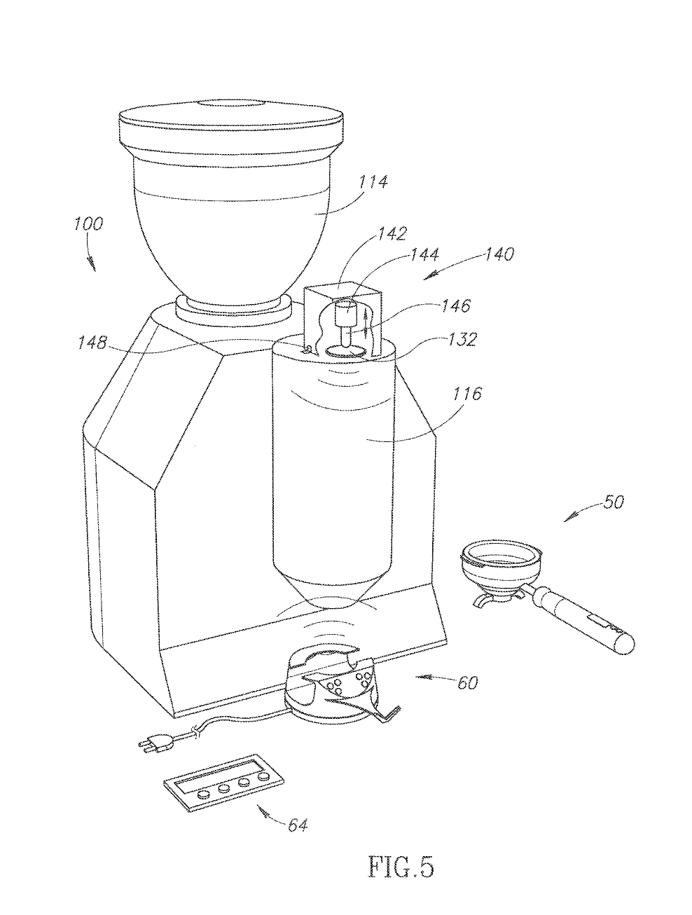

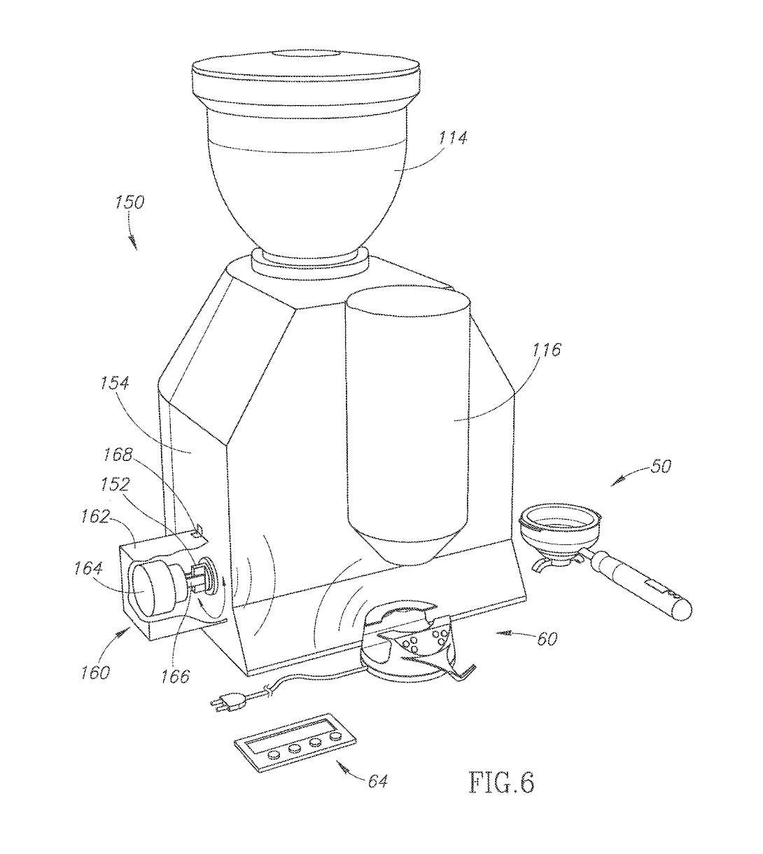

The conventional coffee-grinding apparatus 100 may be any suitable coffee-grinding mechanism known in the art. The coffee-grinding apparatus 100 includes an input portion or hopper 114 configured to store whole coffee beans and to supply the beans to a coffee grinding mechanism 130 (see FIG. 4). The coffee-grinding apparatus 100 also includes an output portion 116 that is operatively associated with the grinding mechanism 130. The output portion 116 may be of any suitable shape, and includes a downwardly directed opening or outlet 117. In operation, the coffee-grinding mechanism 130 receives whole coffee beans from the input portion 114, grinds the coffee beans into ground coffee, and the ground coffee is then dispensed out of the outlet 117 of the output portion 116. To control the operation (e.g., starting and stopping) of the grinding mechanism 130, the coffee-grinding mechanism 100 also includes a coffee-grinding mechanism control input or button 132, which may take any suitable form, including a button, a dial, and the like. The control input 132 may also be located in various locations on the coffee-grinding apparatus 100. In the embodiment shown in FIGS. 1A and 1B, the coffee-grinding apparatus 100 includes the button 132 operative to start and stop the operation of the grinding mechanism 130 when the button is pressed. In another embodiment shown in FIG. 6, a coffee-grinding apparatus 150 includes a dial 152 operative to start and stop the operation of a coffee-grinding mechanism when the dial is selectively rotated.

The coffee-measurement apparatus 60 includes a base portion 61 that has a portafilter platform 80 fixedly or removably disposed on a top surface thereof. The base portion 61 includes a weight-measurement device 20 (see FIG. 4), for example, a load cell, that is operative to measure the weight of the portafilter platform 80 and any objects resting on the portafilter platform. The weight-measurement device 20 is sufficiently robust to allow for baristas to perform “tapping” of the portafilter 50 to settle the coffee “puck” into a compact lower layer. In this regard, the weight-measurement device 20 may include damping features (e.g., mechanical, electronic, and/or computational) which allow it to precisely measure the weight of ground coffee even when tapping or other jarring forces are applied to it.

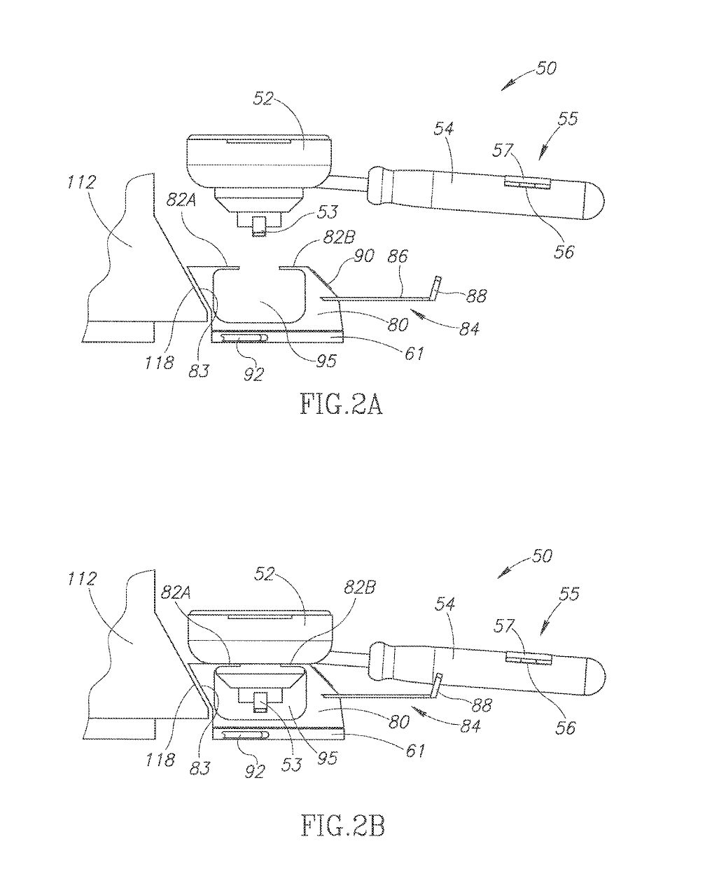

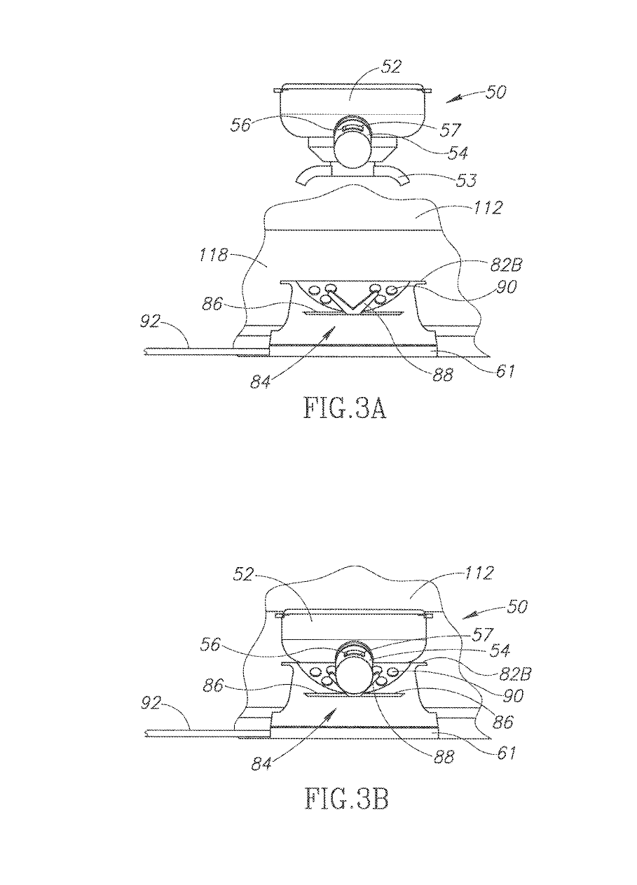

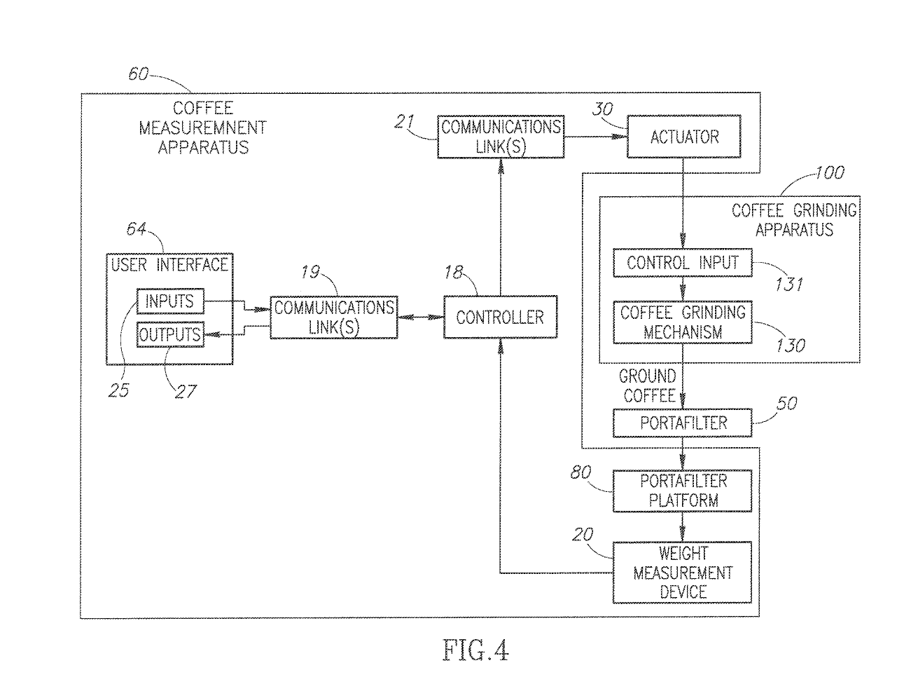

The portafilter platform 80 includes a rear raised basket support portion 82A and a front raised basket support portion 82B for supporting the basket area 52 of the portafilter 50, and a handle support portion 84 for supporting the handle 54 of the portafilter. The raised basket support portions 82A and 82B together form a hollow interior region 95 (see FIGS. 2A and 2B) for receiving the spout portion 53 of the portafilter 50. The handle support portion 84 comprises an elongated beam portion 86 and a handle receiving portion 88.

Further, the portafilter platform 80 is configured to maintain the basket area 52 of the portafilter 50 in a substantially horizontal orientation to reduce the likelihood that ground coffee will spill out of the basket 52 as the ground coffee is dispensed therein. The portafilter platform 80 may be adjustable in one or more ways so that it may be used with various types of portafilters (e.g., portafilters for different types of espresso machines) and/or various types of coffee-grinding devices. As can be appreciated, the portafilter platform 80 maintains the positioning of the portafilter 50 without user intervention. In other words, the portafilter platform 80 permits “hands free” operation by a user. The raised basket support portions 82A and 82B may be configured to permit a slight amount of horizontal movement of the portafilter 50 when it is supported by the portafilter platform 80. By allowing horizontal movement of the portafilter 50, a user may move the portafilter 50 as it is being filled with ground coffee so that the ground coffee evenly fills the portafilter basket 52.

As shown in FIG. 1A, a user may position the coffee-measurement apparatus 60 below an opening 117 of an output portion 116 of the conventional coffee-grinding apparatus 100. As shown best in FIGS. 2A and 2B, the rear raised basket support portion 82A includes an angled outer surface 83 which allows the coffee-measurement apparatus 60 to be placed relatively close to an angled front portion 118 of a base structure 112 of the coffee-grinding apparatus 100. As shown best in FIG. 1B, this feature permits the portafilter basket 52 to be placed directly below the outlet 117 of the output portion 116 of the coffee-grinding apparatus 100. Once the coffee-measurement apparatus 60 is positioned in front of the coffee-grinding apparatus 100 with the portafilter platform 80 directly below the outlet 117 of the output portion, the user may then place the portafilter 50 on the portafilter platform 80 (see FIG. 1B), and operate the coffee-grinding apparatus to fill the portafilter basket 52 to a desired weight.

The coffee-measurement apparatus 60 also includes one or more user interfaces. For example, the coffee-measurement apparatus 60 includes a user interface 64 that may include a plurality of buttons 68 and a display 66. The user interface 64 may include a variety of input and output devices in addition to (or instead of) the buttons 68 and the display 66. Example input and output devices may include keys, dials, touch screens, speakers, and the like. In some embodiments, the user interface 64 may be configured to communicate over a wired or wireless communications link with the coffee-measurement apparatus 60. In the embodiment shown, the user interface 64 is configured to be placed on a counter space near the coffee-measurement apparatus 60. In other embodiments, one or more user interface components including the display 66 may be disposed on the coffee-measurement apparatus 60 itself (e.g., the buttons 90), or may be configured for placement in other suitable locations.

In the illustrated embodiment, another user interface 55 is provided that is configured for fixed or removable attachment to the handle 54 of the portafilter 50. The user interface 55 includes a display 57 and a plurality of buttons 56 (see FIG. 2B). The user interface 55 may be configured for wired or wireless communication with the coffee-measurement apparatus 60. Further, the user interface 55 may be provided in addition to or instead of the user interface 64. As further described below, the display 57 and the buttons 56 of the user interface 55 may permit a user to interact with and receive information from the coffee-measurement apparatus 60.

As shown in FIGS. 1A and 1B, the coffee-measurement apparatus 60 may include a plug 94 and a power cord 92 so that the measurement apparatus may be connected to a power supply (e.g., an electrical wall outlet). In other embodiments, the coffee-measurement apparatus 60 may be powered using other suitable means (e.g., batteries, solar cells, or any combinations thereof).

FIG. 4 illustrates a block diagram of the coffee-measurement apparatus 60 shown in FIGS. 1A-B, 2A-B, and 3A-B. As shown, the coffee-measurement apparatus 60 includes a controller 18 that is operatively connected to the weight-measurement device 20 (e.g., a load cell), operatively connected to inputs 25 (e.g., buttons 90) and outputs 27 (e.g., display 66) of the user interface 64 (and/or other user interfaces) via one or more communications interfaces or links 19. The controller 18 is operative to receive analog or digital signals from the weight-measurement device 20 that correspond to weight measurements of the weight-measurement device. Further, the controller 18 is operative to receive signals from the buttons 68 and 90 (or other available inputs) of the user interfaces and to control the display 66 (or other displays or outputs) of the user interfaces. As can be appreciated, the controller 18 may include features of microcontrollers known in the art. For example, the controller 18 may include one or more processor cores, one or more types of memory (volatile and/or non-volatile memory), communications interfaces, and input/output peripherals. The controller 18 may be application specific or a generally available controller, provided that it is capable of performing the functionality discussed herein.

The communications link 19 and the communications link 21 (discussed below) may be any suitable wired or wireless communications links. The communications links 19 and 21 may enable the controller 18 to communicate with a variety of input and output devices, including one or more displays, one or more speakers, one or more buttons or keys, and the like. Further, the controller 18 may be operative to connect to or “pair” with one or several user interfaces simultaneously using any suitable communications technologies.

The coffee-measurement apparatus 60 may also be operative to receive and store one or more desired weights entered by a user via an input of a user interface or pre-programmed into a persistent memory of the measurement apparatus (e.g., in a suitable memory associated with the controller 18). The desired weight may be modifiable and/or selectable by the user, and may be displayed on a display of one or more user interfaces. In operation, the user may operate the conventional coffee-grinding apparatus 100 to dispense ground coffee directly into the basket 52 of the portafilter 50 positioned on the portafilter platform 80 (see FIG. 1B). The net weight of ground coffee may be continuously measured and compared to the selected desired weight. Once the net weight of ground coffee in the portafilter basket 52 has reached the selected desired weight, one or more outputs (e.g., the display 66) may provide an indication signaling the user to manually stop the operation of the coffee-grinding apparatus 100, for example, by pressing the button 132 of the coffee-grinding apparatus 100 of FIGS. 1A and 1B. As an example, the displays 66 and/or 57 may display a “Desired Weight Reached” message. Additionally or alternatively, the displays may provide a substantially real-time indication of status to the user (e.g., in the form of a progress bar or other graphical display). This feature may alert the user to be prepared to manually stop the coffee-grinding apparatus 100 as the net weight approaches the desired weight. As another example, one or more of the user interfaces may include an audio generating device (e.g., a speaker) to alert the user when the net weight of ground coffee has reached or is approaching the desired weight.

Once the desired weight of ground coffee has been dispensed into the portafilter basket 52, a user may then remove the portafilter 50 from the portafilter platform 80 and, after suitable tamping (to compact the ground coffee within the portafilter basket), may immediately attach the portafilter 50 to an espresso machine (not shown) to prepare a shot of espresso. Since the user does not have to transfer the ground coffee between one or more temporary measurement containers, the likelihood of spilling any of the ground coffee is substantially reduced, resulting in more consistent espresso shots. Further, since no additional time is required to transfer ground coffee between containers, there is less time for the temperature of the portafilter 50 to decay during the measurement process.

As shown in FIG. 4, in some embodiments the coffee-measurement apparatus 60 may include an actuator 30 (e.g., an electronic connection or actuator and/or an electromechanical actuator) operative to automatically control the operation of the coffee-grinding apparatus 100 by actuating a control input 131 (e.g., the button 132 shown in FIGS. 1A and 1B). The controller 18 is operatively coupled to the actuator 30 via the communications link 21, which may be any suitable wired or wireless communications link. During operation, the actuator 30 may be operated to automatically start the coffee-grinding mechanism 130 of the coffee-grinding apparatus 100 by actuating the control input 131. Once the net weight of ground coffee has reached the desired weight, the controller 18 may send a signal to the actuator 30 to cause it stop the operation of the coffee-grinding apparatus 100. In addition, an indication that the desired weight of coffee has been reached may be provided to the user (e.g., via the outputs 27 the user interface 64). As can be appreciated, depending on the specific design of the coffee-grinding apparatus 100, ground coffee may continue to be dispensed for a short period of time after the coffee-grinding mechanism 130 has stopped operating. In this case, the controller 18 may signal the coffee-grinding mechanism 130 to stop operating just before the net weight reaches the desired weight so that once the coffee-grinding mechanism has stopped, the net weight of ground coffee equals the desired weight. In this regard, the coffee-measurement apparatus 60 may include functionality to allow a user to “train” the apparatus using feedback to stop the grinding mechanism 130 at the appropriate time. Further, the actuator 30 may be operative to rapidly actuate or “pulsate” the control input 131 to achieve more accurate dispensing and weight-measurement.

In embodiments where the actuator 30 utilizes an electronic connection, the coffee-measurement apparatus 60 is operative to control the start/stop functions of the coffee-grinding apparatus 100 by means of electronic signals that interface directly or indirectly with the internal electronic components of the coffee-grinding apparatus.

FIGS. 5 and 6 illustrate two examples of electromechanical actuators 140 and 160, respectively, that may be used to mechanically actuate a control input of a coffee-grinding apparatus. The electromechanical actuator 140 shown in FIG. 5 is configured to mechanically actuate the control input button 132 of the coffee-grinding apparatus (also shown in FIGS. 1A and 1B). The actuator 140 includes a housing 142 coupled to a top surface of the output portion 116 of the coffee-grinding apparatus 100 via a fastener 148. The fastener 148 may include any type of device configured to securely and removably fasten the actuator 140 to the apparatus 100 over the button 132. The actuator 140 also includes a switch mechanism 144 coupled to a movable actuating member 146 configured for vertical displacement so that it may selectively press the button 132 of the coffee-grinding apparatus 100. The switch mechanism 144 may comprise any suitable electromechanical actuator means (e.g., a screw, wheel and axle, cam, or the like) to cause linear displacement of the actuating member 146.

The electromechanical actuator 160 shown in FIG. 6 is configured to operate with a coffee-grinding apparatus 150 that includes a control input dial 152 positioned on a side of a base 154 configured to control the starting and stopping of the grinding mechanism of the coffee-grinding apparatus 150. The electromechanical actuator 160 includes a housing 162 coupled to the base 154 via a fastener 168. Like the actuator 140 described above, the actuator 160 includes a switch mechanism 164. The switch mechanism 164 is coupled to prongs 166 that are operative to selectively rotate the dial 152 to start and stop the grinding mechanism of the coffee-grinding apparatus 150 when directed to do so by the coffee-measurement apparatus 60.

It will be appreciated that other types of actuators may be used to provide the functionality described herein. As an example, different actuators may be provided that work with individual types of conventional coffee grinders. In this regard, new actuators may be provided as new coffee grinders are introduced to the market, such that the coffee-measurement apparatus 60 may be “adapted” to work with a variety of existing and new coffee grinders. Further, as discussed above, the coffee-measurement apparatus 60 may operate with or without using an electromechanical actuator to automatically control the operation of a coffee-grinding apparatus. In the illustrated embodiments, the electromechanical actuators 140 and 160 are configured for wireless communication with controller 18 of the coffee-measurement apparatus 60. In other embodiments, a wired communication link may be provided. Further, although not shown, the electromechanical actuators 140 and 160 may be powered by any suitable means, including batteries, solar cells, A/C power, or any combinations thereof.

As discussed herein, the embodiments of the present invention provide several advantages that are immediately recognizable. The present invention enables the dispensing of a precise mass of ground coffee, as measured by its weight, directly into the basket of a portafilter of an espresso machine. Further, by providing a specialized portafilter platform configured to position a portafilter basket directly below an output portion of a coffee-grinding apparatus, the time required for measuring ground coffee and the likelihood of spilling the ground coffee are greatly reduced. Those skilled in the art will readily recognize other advantages provided by the various embodiments of the present invention.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.).

It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

1. A method for delivering a precise weight of ground coffee to a portafilter basket, the method comprising:
providing a coffee-grinding apparatus with a coffee-grinding mechanism and a ground coffee output portion;
providing a portafilter having a basket, a liquid spout depending from the basket, and an elongated handle;
providing a coffee-measurement apparatus connected to the coffee-grinding apparatus that comprises a portafilter platform and a weight-measurement device, the portafilter platform comprising a basket support portion located directly under said output portion and a handle receiving portion distanced from the basket support portion;
placing the portafilter basket on the basket support portion and operating the coffee-grinding mechanism of the coffee-grinding apparatus to dispense ground coffee from the output portion into the portafilter basket;
wherein the basket support portion has a gap for receiving the liquid spout, and the method further comprises moving the portafilter horizontally on the basket support portion to evenly fill the basket during said dispensing of ground coffee; and
resting the portafilter hands-free on the portafilter platform with the basket on the basket support portion and the handle on the handle receiving portion so that the weight-measurement device measures the weight of the portafilter basket plus the ground coffee in the basket.

2. The method as in claim 1, further comprising calculating a measured weight of ground coffee in the basket by subtracting a tare weight of the portafilter from the weight of the portafilter basket plus the ground coffee.

3. The method of claim 2, wherein said resting the portafilter hands-free on the portafilter is performed during dispensing of ground coffee into the basket and the method further comprises displaying the measured weight of ground coffee on a display as the ground coffee is being dispensed.

4. The method as in claim 3, further comprising stopping the operation of the coffee-grinding mechanism when the measured weight of the ground coffee reaches, or reaches near to, a desired weight of ground coffee.

5. The method of claim 4, wherein operating the coffee-grinding mechanism and stopping the operating of the coffee-grinding mechanism are performed using an external actuator configured to actuate a control input of the coffee-grinding apparatus.

6. The method of claim 5, wherein said stopping the operation is performed by a controller in communication with the coffee-grinding apparatus, and the method further comprises:
providing a user interface that is in communication with the controller and that comprises said display; and
inputting to the controller said desired weight of ground coffee by means of the user interface.

7. The method of claim 6, wherein at least a part of communication between the user interface and the controller is via a wireless communications interface.

8. The method of claim 6, wherein the controller further comprises a memory, and wherein said desired weight of ground coffee is input to the controller by means of the user interface and stored in said memory.

9. A method for delivering a precise weight of ground coffee to a portafilter basket, the method comprising:
providing a coffee-grinding apparatus with a coffee-grinding mechanism and a ground coffee output portion;
providing a portafilter having a basket, a liquid spout depending from the basket, and an elongated handle;
providing a coffee-measurement apparatus connected to the coffee-grinding apparatus that comprises a portafilter platform and a weight-measurement device, the portafilter platform comprising a basket support portion located directly under said output portion and a handle receiving portion distanced from the basket support portion;
resting the portafilter hands-free on the portafilter platform with the basket on the basket support portion and the handle on the handle receiving portion and operating the coffee-grinding mechanism of the coffee-grinding apparatus to dispense ground coffee from the output portion into the portafilter basket, so that the weight-measurement device measures the weight of the portafilter basket plus the ground coffee in the basket during said dispensing.

10. The method as in claim 9, further comprising calculating a measured weight of ground coffee in the basket by subtracting a tare weight of the portafilter from the weight of the portafilter basket plus the ground coffee.

11. The method of claim 10, further comprising displaying the measured weight of ground coffee on a display as the ground coffee is being dispensed.

12. The method as in claim 11, further comprising stopping the operation of the coffee-grinding mechanism when the measured weight of the ground coffee reaches, or reaches near to, a desired weight of ground coffee.

13. The method of claim 12, wherein operating the coffee-grinding mechanism and stopping the operating of the coffee-grinding mechanism are performed using an external actuator configured to actuate a control input of the coffee-grinding apparatus.

14. The method of claim 12, wherein said stopping the operation is performed by a controller in communication with the coffee-grinding apparatus, and the method further comprises:
providing a user interface that is in communication with the controller and that comprises said display; and
inputting to the controller said desired weight of ground coffee by means of the user interface.

15. The method of claim 14, wherein at least a part of communication between the user interface and the controller is via a wireless communications interface.

16. The method of claim 14, wherein the controller further comprises a memory, and wherein said desired weight of ground coffee is input to the controller by means of the user interface and stored in said memory.
